(19) United States
(12) Patent Application Publication
(10) Pub. No.: US 2006/0265712 A1
(43) Pub. Date: Nov. 23, 2006

(54) Methods for supporting intra-document parallelism in XSLT processing on devices with multiple processors

(75) Inventors: Dong Zhou, San Jose, CA (US); Nayeem Islam, Palo Alto, CA (US); Marion C. Lineberry, Dallas, TX (US); Dannellia Gladden-Green, Round Rock, TX (US)

Correspondence Address: MACPHERSON KWOK CHEN & HEID LLP, 1762 TECHNOLOGY DRIVE, SUITE 226, SAN JOSE, CA, 95110, US

(73) Assignees: DoCoMo Communications Laboratories USA, Inc.; Texas Instruments Inc.

(21) Appl. No.: 11/231,430

(22) Filed: Sep. 20, 2005

Related U.S. Application Data
(60) Provisional application No. 60/682,599, filed on May 18, 2005.

(51) Int. Cl. G06F 9/46

(52) U.S. Cl. 718/102

(57) ABSTRACT

As mobile handsets are typically much slower than desktops for processing intensive applications, and as XSL-based XML document transformations (or XSLT) are processing intensive, such transformations are costly on mobile devices both because of execution time and energy consumption. While other processing intensive applications, such as voice communication and graphics rendering, have exploited options in the design of mobile processor architecture, similar methodologies have not been applied to XSLT processing. A method for parallelizing XSLT processing on devices with multiple processors is therefore devised. The method divides XSLT processing into separately schedulable subtasks, synchronizes these subtasks, and schedules such subtasks on multiple processors for improved time and energy efficiency.

### CROSS-REFERENCE TO RELATED APPLICATIONS

The present application relates to and claims priority of U.S. Provisional Patent Application (“Co-pending Provisional Application”), Ser. No. 60/682,599, entitled “Method for Supporting Intra-document parallelism in XSLT processing on devices with multiple processors,” filed on May 18, 2005, and bearing attorney docket number M-15952-V IUS. The disclosure of the Co-pending Provisional Application is hereby incorporated by reference in its entirety.

### BACKGROUND OF THE INVENTION

1. Field of the Invention

The present invention relates to processing XML documents. In particular, the present invention relates to a method for parallel processing XSL transformations (XSLTs) of an XML document.

2. Discussion of the Related Art

XML documents may be transformed into an XML or another type of document (e.g., HTML), for example, using Extensible Stylesheet Language (XSL) transformation, or XSLT. The resulting document from the transformation is typically in a better form for processing by an application (e.g., a web browser). XSLT, which became a W3C Recommendation in November, 1999, is described in XSL Transformations (XSLT), Version 1.0. A copy of this recommendation may be obtained from http://www.w3.org/TR/xslt. Typically, XSLT operates on a document that may be represented in a tree structure. Under XSLT terminology, the source document is called the “source tree” and the transformed document is called the “result tree.”

In a typical transformation process, XSLT uses the XML Path Language (“XPath”) to define the matching patterns for transformation. XPath addresses the different parts of an XML document. When a source tree matches the parts of the XML document defined in XPart, XSLT transforms the source tree to the resulting tree.

XSLT processing, however, is both computationally intensive and memory access intensive. Further, XSLT processing typically runs significantly slower on a mobile device than on a desktop computer because the mobile device typically operates at a lower processor frequency and a lower memory bandwidth, and runs relatively less sophisticated software. Such deficiencies are typically overcome using dedicated hardware (e.g., a special purpose co-processor or hardware block). For example, in addition to a general-purpose RISC processor, a modern cellular telephone handset typically has a base-band processor for voice communication. In some instances, a cellular telephone handset may also have a DSP co-processor for graphics rendering. Although providing additional capabilities by adding dedicated additional hardware may appear to be a viable approach to providing XSLT processing in a mobile device, such an approach is costly. Accordingly, providing the additional capabilities using a device's general-purpose processor, rather than by adding dedicated hardware, is desired.

Performance can be achieved by exploiting parallelism. In the context of document processing, inter-document parallelism refers to concurrently transforming multiple documents on multiple machines or processors, with each document handled by only one machine or processor at any time. Such parallelism can be achieved using traditional parallel or distributed computing tools. In such a tool, one of the machines typically serves as master, while the other machines serve as slaves. The master machine sends to each slave machine a “style sheet” and a source document for transformation, and each slave machine sends the result document back to the master machine after completing the requisite transformation. Currently, XA35 XML Accelerator¹ and Speedway XSLT Accelerator² are commercially available products employing this approach for XSLT processing acceleration.
¹ XA35 XML Accelerator is available from Data Power Technology, Inc., http://www.datapower.com/products/xa35.html

² The Sarvega Speedway XSLT Accelerator is available from Sarvega, Inc., http://www.sarvega.com/xml-speedway-accelerator.php.

Inter-document parallelism can also be achieved on symmetric multi-processor platforms using existing threading facilities. Under this approach, multiple threads of execution can be created, with each thread running on one processor and handling the transformation of one document. U.S. Patent Application Publication, US20030159111, entitled “System and Method for Fast XSL Transformation,” published on Aug. 21, 2003, describes achieving parallel XSL transformation by caching a pool of transformer threads and allowing concurrent transformation of multiple documents.

International Patent Application Publication W02002091170 “Dedicated Processor for Efficient Processing of Documents Encoded in a Markup Language,” filed May 1, 2002, discloses improving document processing using an asymmetric multi-processor platform. In this asymmetric multi-processor platform, a special-purpose processor is provided for XML processing, including XSLT transformations. Consequently, a general-purpose processor becomes more available for performing other tasks.

Inter-document parallelism targets throughput improvement, which is best suited for a server environment, especially in an enterprise application. However, for a mobile handset, latency and energy efficiency are much more important considerations than throughput.

Intra-document parallelism refers to using multiple machines or processors to handle the transformations on one document. Under such an approach, more than one machine or processor executes transformations on the same document concurrently, for at least some portion of the total execution time. International Patent Application Publication WO01 095155, entitled “Method and Apparatus for Efficient Management of XML Documents,” published on Dec. 13, 2001, discloses treating documents as a form of distributed shared objects, so that a document and its processing code may be handled by multiple machines concurrently. Under this approach, each machine runs the processing code locally to modify the document. Locally made updates are propagated and synchronized.

The distributed shared object approach, however, is also not practical in a mobile handset environment, where the cost of synchronization throughout the wireless access network can easily negate any benefit gained through distributed processing. Moreover, the above-mentioned International Patent Application Publication does not disclose any method for the intra-document parallelization of XSL transformation.

Tarari RAX-CP Content Processor³ provides a hardware implementation of an XPath Processor for evaluating XPath requests. This XPath Processor runs in parallel with one or more other processors, and can handle simultaneous requests. However, the Tarari RAX-CP Content Processor only parallelizes XPath expression evaluations but not the rest of the transformations. Since XPath expression evaluations are not the dominant part of the total cost in XSL transformation, the resulting improvements in both execution time and energy efficiency are limited.
³ Random Access XML (RAX) Content Processor is available from Tarari, Inc., http://www.tarari.com/rax/index.html.

### SUMMARY

According to one embodiment of the present invention, a method is disclosed that divides an XSL transformation process into separately schedulable subtasks, synchronizes the separately scheduled XSLT processing subtasks and merges the processing results. XSL transformations include (a) source document parsing, which generates a tree representation of the source document; (b) node selection and template matching, which are typically activated by an “apply-template” element of a style sheet; and (c) template execution, where a template is applied to a node.

In one embodiment, each XML element is parsed by a separate subtask, denoted a “parsing task” or “PT” subtask. Since parsing an element involves parsing its children elements and other constructs (e.g., text node and processing instruction), a PT subtask can be nested in another (“parent”) PT subtask. Node selection and template matching are carried out in a “matching task” or “MT” subtask. An MT subtask may result from one or more PT subtasks, and may generate one or more template execution (“ET”) subtasks. An ET subtask is spawned by an MT subtask. An ET subtask may result from the completion of one or more PT subtasks, and may spawn one or more MT subtasks.

In one embodiment, the source tree is shared among all subtasks, with the PT subtasks writing into the source tree, while the MT and ET subtasks read from the source tree. MT and ET subtasks also share the result tree. A parent PT subtask is blocked while any of its children PT subtasks is still processing. A blocked PT subtask sets a flag at its corresponding node in the document tree.

An ET subtask allocates a “place holder” for an MT subtask, so that the transformation result of the MT can be later merged into the result document. An ET subtask that reads or writes variables is blocked until all other ET and MT subtasks whose results the ET subtask depends have completed. In one embodiment, the ET and PT subtasks are ordered as follows: (a) ET subtasks created by the same MT subtask are completed in order of creation; (b) MT subtasks created by the same ET subtask are completed in order of creation; and (c) a child ET subtask of an MT subtask that is created by a parent ET subtask completes before the parent ET subtask completes.

An ET subtask is blocked on a PT subtask when it is possible that the ET subtask may access the children of the node corresponding to the PT subtask before the PT subtask completes. The blocked ET subtask is placed on a blocked list of the PT subtask. The ET subtask is removed from the blocked list when the blocking PT subtask completes. An MT subtask is blocked by a PT subtask when it is possible that the MT subtask may evaluate an XPath expression before the variables whose values the XPath expression depends are fully evaluated. The MT subtask is placed in a blocked list of the PT subtask. For Node-Set expressions (i.e., expressions that evaluate to XML document nodes), the MT subtask is notified when the PT subtask makes progresses (e.g., completing parsing of a child element).

According to another embodiment of the present invention, a method is disclosed which schedules subtasks on multiple processors of a mobile device to improve execution time and energy efficiency of document transformation. In one embodiment, the subtasks are assigned to the processors using, for example, a real-time scheduling algorithm. The real-time scheduling algorithm may be one commonly implemented by a multi-processor, real-time operating systems or may be a customized algorithm running as a task on one of the processors.

According to one embodiment of the present invention, the real-time scheduling algorithm receives two types of input values: static and dynamic. Static input values relate to the hardware architecture, and dynamic input values relate to the current state of the processing environment (e.g., processor loads, bus bandwidths, battery level and data dependencies).

In one embodiment of the present invention, offline profiling provides statistical information about the relative cost-effectiveness of each processor's handling of different tasks. The statistical information may be presented, for example, in table form. Each entry of such a table may contain, for example, profile data for each task class. Profile data includes, for example, the task class and normalized metrics indicating the cost-effectiveness of running tasks of that class on each of the processors. The cost-effectiveness metrics indicate either the execution time or the energy consumption on a processor. The metrics may be normalized against corresponding metrics on a reference processor.

In one implementation, tasks can be classified at different levels of granularity. For example, at the coarsest level of granularity, tasks may be classified as MT, PT and ET subtasks. At a medium level of granularity, tasks may be classified as a subtask relative to a style sheet (e.g., “MT subtask with style sheet A”, “PT subtask with style sheet A⁴”, and “ET subtask with style sheet A”). At the finest level of granularity, tasks may be classified with respect to a style sheet and a document type (e.g., “MT subtask with style sheet A on a type T document”, “PT subtask with style sheet A on a type T document”, and “ET with style sheet A on a type T document”).
⁴ Note the PT subtask is actually parsing the source document, not the style sheet.

In one embodiment, when the profile information for multiple levels of task granularity is available, the real-time scheduling algorithm uses the profile information associated with the finest level of task granularity. For example, if information for general MT subtasks and information for MT subtasks with style sheet A are both available, the real-time scheduling algorithm chooses information for MT subtasks with style sheet A.

According to one embodiment of the present invention, the real-time scheduler maintains a task list of the ready tasks (i.e., tasks that are not blocked). For each idle processor, the scheduler assigns it a task from the task list, based on the cost-effectiveness metrics on the processor. When the task list is not empty, but there are idle processors, the scheduler takes note of the busy processors and the tasks that they are running, and increase the stall count for the (processor, task) pair.

In one embodiment, the stall count for a (processor, task) pair is used to adjust the time cost-effectiveness metric for the (processor, task) pair. Such an adjustment addresses the skew due to a specific source document. Alternatively, the position of the source document node associated with the task may also be used to adjust cost-effectiveness metric. A source document node far away from the root node is more likely to cause cache misses than a node that is close to the root node. Consequently, a processor with a larger cache than the reference processor should have a higher cost-effectiveness metric for tasks associated with nodes far away from the root node, while processors with a smaller cache have a lower cost-effective metric.

The present invention thus provides intra-document parallelism in processing XSL transformation subtasks. Unlike the prior art inter-document parallelism, which does not improve its latency (i.e., the elapsed time between start of the processing of a document and the end of the processing), the intra-document parallelism improves latency, and consequently, is more relevant to mobile devices.

The invention further exploits features of XSLT processing to improve the effectiveness. Such XSLT processing features include style sheet-specific profiling and source document structure-specific profiling. In one embodiment, stall count and node depth are measured to dynamically adjust skews in profiling information caused by specific document or node.

The present invention is better understood upon consideration of the detailed description below and the accompanying drawings.

### BRIEF DESCRIPTION OF THE DRAWINGS

FIG. 1 is a flow chart illustrating a root element parsing method, according to one embodiment of the present invention.

FIG. 2 is a flow chart illustrating a root element transforming method, according to one embodiment of the present invention.

FIG. 3 is a flow chart illustrating a method for XSL transformation, according to one embodiment of the present invention.

FIG. 4 is an example of a subtask graph, in accordance with one embodiment of the present invention.

FIG. 5 is a flow chart illustrating a baseline scheduler, according to one embodiment of the present invention.

FIG. 6 is a flow chart illustrating a scheduler that takes into consideration static or offline profiling information relating to energy consumption of a task, according to one embodiment of the present invention.

FIG. 7 is a flow chart illustrating a scheduler that takes into consideration static or offline profiling information relating to execution time of a task, according to one embodiment of the present invention.

FIG. 8 is a flow chart illustrating a scheduler that takes into consideration both static or offline profiling information and dynamic profiling information, according to one embodiment of the present invention.

FIG. 9 illustrates a process for executing an MT subtask, according to one embodiment of the present invention.

FIG. 10 illustrates a process for executing an PT subtask, according to one embodiment of the present invention.

FIG. 11 illustrates a process for executing an ET subtask, according to one embodiment of the present invention.

### DETAILED DESCRIPTION OF THE PREFERRED EMBODIMENTS

In this detailed description, the embodiments disclosed are, by way of example, applicable to a computer system in which all the processors or processes are capable of executing all task classes. The present invention, however, is not so limited. The present invention is applicable also to a computer system in which some or all of the computer processors or processes are customized to executing specific task classes.

According to one embodiment of the present invention, as illustrated in FIG. 3, an XSL transformation (XSLT) is started at step 301 on one of the processors (an “initial processor”) of a computer system with multiple processors. The source document and the style sheet are acquired at steps 302 and 303, respectively. If the style sheet is not already loaded in this initial processor, the style sheet is loaded and preprocessed.

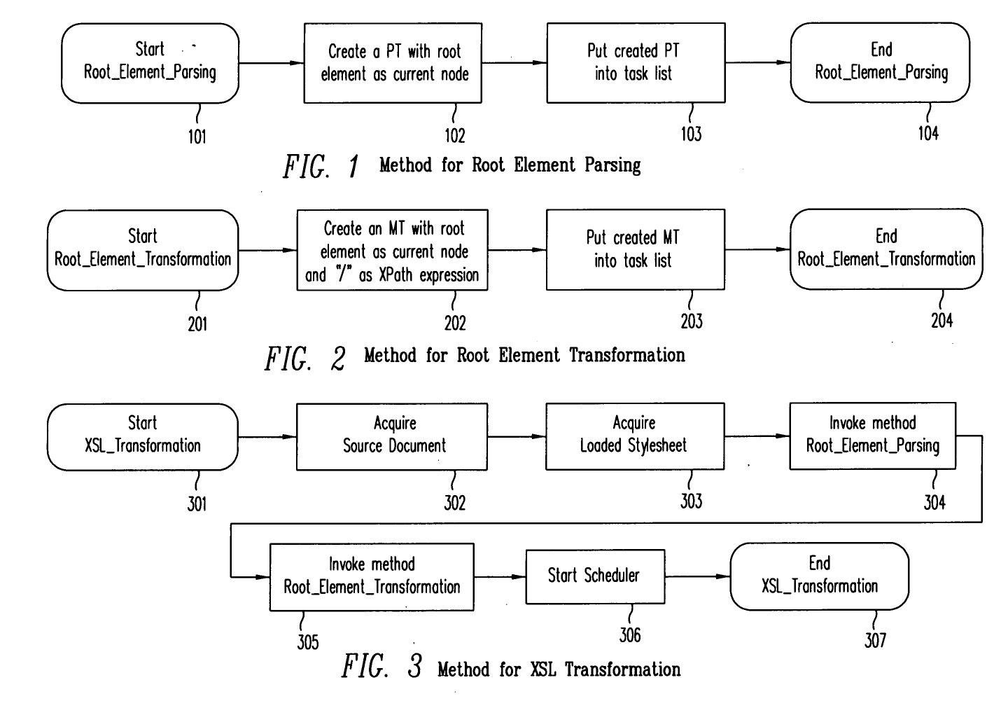

At steps 304 and 305, a root element parsing method (illustrated in FIG. 1) and a root element transformation method (illustrated in FIG. 2) are respectively invoked. The root element parsing method, which is shown in FIG. 1 as being initated at step 101, creates a “parsing task” or “PT” subtask at step 102 with the root element of the source document as the associated node. At step 103, the created PT subtask is put into a task list (“XSLT subtask list”). The root element parsing method then teminates (step 104). The root element transformation method, which is shown in FIG. 2 as being initiated at step 201, creates a “matching task” or “MT” subtask with the root element of the source element as the associated node at step 202. At step 202, the “/” character is also provided as the XPath expression as the “node set” selection. The created MT subtask is then put into the XSLT subtask list before the root element transformation method terminates at step 204.

After initiating the root element parsing and the root element transformation methods at steps 304 and 305, the XSLT then starts a scheduler on each of the processors at step 306, and control for the remainder execution of the XSL transformations is transferred to these schedulers. The XSLT on the initial processor then terminates at step 307.

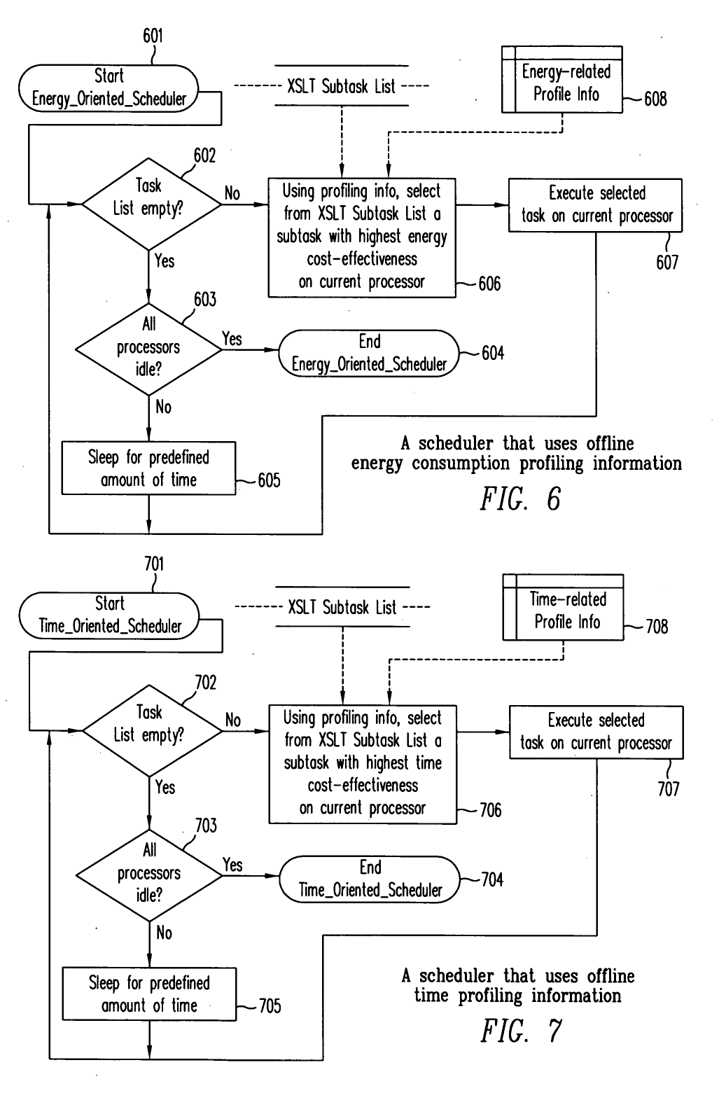

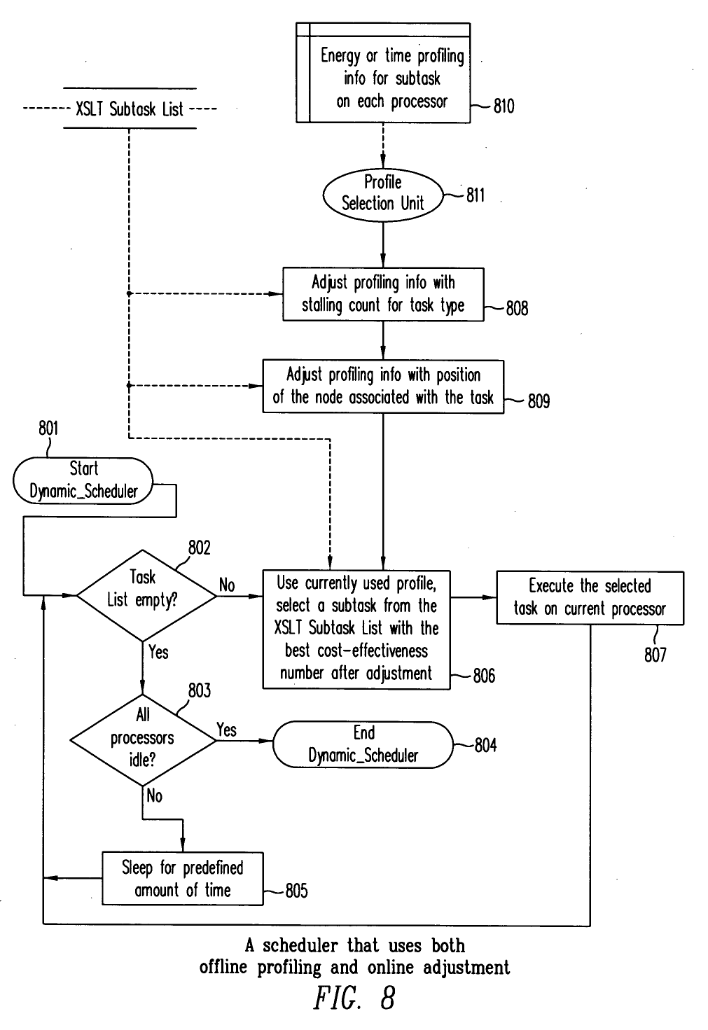

The scheduler started by the XSLT in each processor is the same one for all the processors for each source document and style sheet pair. That scheduler may be a baseline scheduler (e.g., the scheduler illustrated in FIG. 5), a scheduler that takes into consideration static or offline energy consumption profile information of a task (e.g., the scheduler illustrated in FIG. 6), a scheduler that takes into consideration static or offline execution time profile information of a task (e.g., the scheduler illustrated in FIG. 7), or a scheduler that takes into consideration both offline profile information and dynamic profile information (i.e., profile information that is adjusted at run-time). A scheduler that takes into consideration both static and dynamic profiling information is illustrated in FIG. 8.

As shown in FIG. 5, upon initiation at step 501, the baseline scheduler checks if the XSLT subtask list is empty (step 502) and if a processor is executing a task (step 503). If the XSLT subtask list is empty and all the processors are idle, then the XSLT is completed, and the scheduler terminates (step 504). Otherwise, if the XSLT subtask list is empty while one or more processors are executing tasks, the scheduler sleeps or blocks for a predefined amount of time (step 505) before returning to step 502 to examine the task list again. If the XSLT subtask list is not empty, the scheduler selects and removes a task from the XSLT subtask list at step 506. As the XSLT subtask list is a shared resource accessed by all the processors, a mutual exclusion mechanisms (e.g., a lock) is preferably provided to prevent concurrent, unsupervised accesses to the XSLT subtask list. The scheduler then transfers control to the selected task at step 507. Upon completion of the selected task, control is yielded back to the scheduler at step 502.

In this embodiment, each task in the XSLT subtask list may include: (a) subtask type, which can be PT, MT, or ET; (b) the name of the style sheet (may be implicitly provided as a single style sheet is used for all subtasks in this embodiment); (c) the associated source document node; (d) the identity of the template, if the subtask type is “ET”; (e) the associated XSL element, if the subtask type is “MT”. Other than the subtask type field, the information in the other fields is desirable to facilitate processing, but is not necessary, as the information can be determined during the execution of the task.

FIG. 6 illustrates a scheduler running on a processor that takes into consideration an energy-consumption profile to select a task for execution on the processor. Unlike the baseline scheduler of FIG. 5, the scheduler of FIG. 6 uses a table 608 that contains energy-related cost-effectiveness profile information to select a subtask from the XSLT subtask list. For each subtask on the XSL subtask list, the scheduler looks up an energy-related cost-effectiveness metric from the energy-related cost-effectiveness profile information in table 608, using a description of the subtask.

The following table is an exemplary energy profiling table. The columns of the energy profiling table are: (a) task type (PT, MT or ET), (b) task identifier (ID), (c) processor ID, and (d) energy consumption index.

In this embodiment, a number of task IDs representing characterized tasks may be defined. If a task ID of a task is not provided in the table, the task takes on the “default” value relevant to its task type. All PTs may use the same default value, as source documents are deemed more dynamic than style sheets (i.e., XSLT documents). In the following table, the third column provides a processor ID which, in this instance, assuming includes two processors labeled “processor 1” and “processor 2”. The fourth column provides, for each task type and task ID, a normalized energy consumption index representing the relative energy consumption rates when a task of the corresponding task type and task ID is executed to each of the two processors, based on profiling statistics gathered.

| Task Type | Task ID | Processor # | Energy Consumption |
|---|---|---|---|
| PT | Default | 1 | 1 |
| PT | Default | 2 | 0.3 |
| MT | Default | 1 | 1 |
| MT | Default | 2 | 0.95 |
| MT | MT001 | 1 | 1 |
| MT | MT001 | 2 | 1.2 |
| ET | Default | 1 | 1 |
| ET | Default | 2 | 1.5 |
| ET | ET001 | 1 | 1 |
| ET | ET001 | 2 | 3.3 |

For example, when a task having a process ID “PT001” is scheduled to run, the table is accessed. Since task PT001 is not specifically found in the table, the table entries the default PT task type are applicable. As shown in the table, parsing tasks run more energy efficiently on processor 2 than processor 1 (energy consumption index being 0.3 on processor 2, rather than 1 on processor 1), task PT001 is scheduled to run on processor 2. As another example, table entries for the MT task having task ID “MT001” are found in the table. As the energy consumption index is lower when executed in processor 1 (1) than in processor 2 (1.2), task MT001 is scheduled to run on processor 1. Similarly, task MT002 of the MT task type is scheduled to run on processor 2, as the default table entries suggest that task MT002 would be more efficient running on processor 2.

Accordingly, the subtask having the highest cost-effectiveness metric is selected (step 606) for execution in the processor and removed from the XSL subtask list. Control of the processor is then yielded to the selected subtask (step 607).

FIG. 7 illustrates a scheduler running on a processor that takes into consideration an execution time to select a task for execution on the processor. Unlike the baseline scheduler of FIG. 5, the scheduler of FIG. 7 uses a table 708 that contains execution time-related cost-effectiveness profile information to select a subtask from the XSLT subtask list. For each subtask on the XSL subtask list, the scheduler looks up an execution time-related cost-effectiveness metric from the execution time-related cost-effectiveness profile information in table 608, using a description of the subtask. A time-related cost-effectiveness metric can be provided in a table in the same manner as the energy consumption profiling data in the table above (i.e., instead of a normalized energy consumption index, a normalized execution time index may be provided). The subtask having the highest time-related cost-effectiveness metric is selected (step 706) for execution in the processor and removed from the XSL subtask list. Control of the processor is then yielded to the selected subtask (step 707).

FIG. 8 illustrates a scheduler that uses both offline profile and online profile adjustment to select a subtask for execution on its associated processor. Unlike the schedulers of FIGS. 6 and 7, which uses static or offline profile information to assist in task selection, the scheduler of FIG. 8 adjusts the static profile information using run-time information. As shown in FIG. 8, for example, at steps 810 and 811, the relevant energy-related or execution time-related profile information is selected for each processor. At steps 808 and 809, the selected profile information is adjusted for dynamic conditions in the processor. For example, at step 808, a stall count may be kept on a (processor, subtask) pair, so as to adjust the cost-effectiveness metric of the subtask, if execution time-related profiling information is used. As another example, the scheduler may also examine the depth of the node inside the source document associated with the current subtask (step 809) to adjust the cost-effectiveness metric for the subtask, when either execution time- or energy-related profiling information is used. For each subtask on the XSL subtask list, the scheduler looks up a corresponding cost-effectiveness metric based on the adjusted cost-effectiveness profile information in table 808, using a description of the subtask. The subtask having the highest cost-effectiveness metric is selected (step 806) for execution in the processor and removed from the XSL subtask list. Control of the processor is then yielded to the selected subtask (step 807).

In one embodiment, the scheduler adapts to the operating environment by: (a) being selectably made to use exclusively execution time-related or energy-related profile information, based on a determination of power availability; or (b) dynamically selecting between two or more sets of profiling information based on current power availability, desired quality of service metrics or default priority levels. This method maintains a dynamic balance between power consumption and execution time. With full power availability, the balance may be tilted toward speed of execution. Conversely, the balance may be tilted toward power consumption, as power availability decreases. At any given time, a weighted combination of both execution time and power consumption may be used.

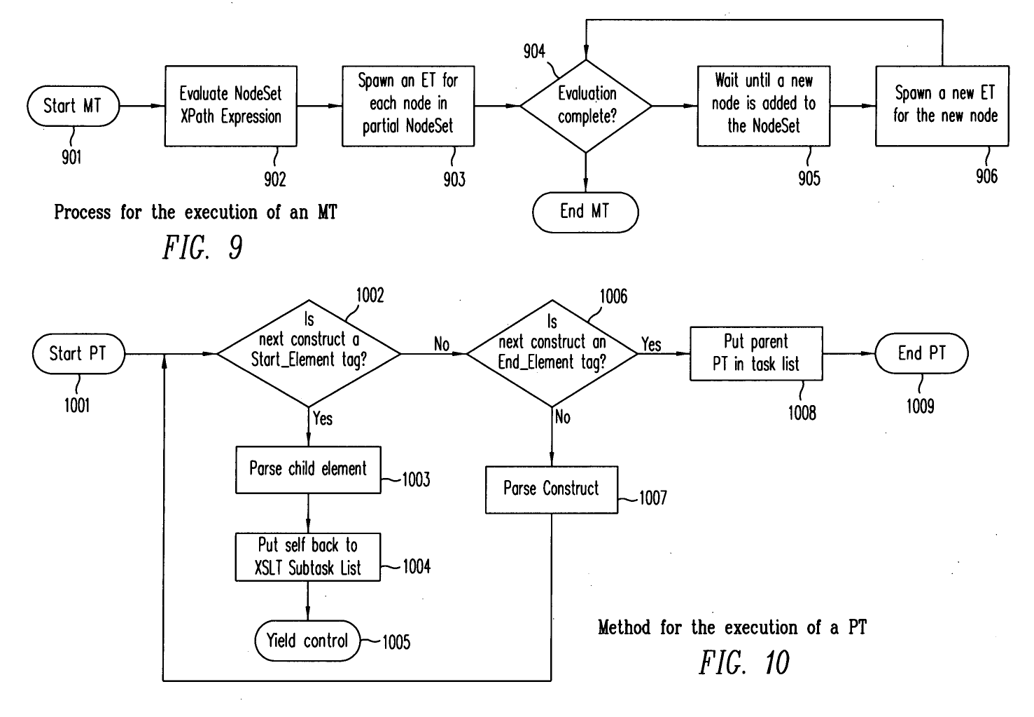

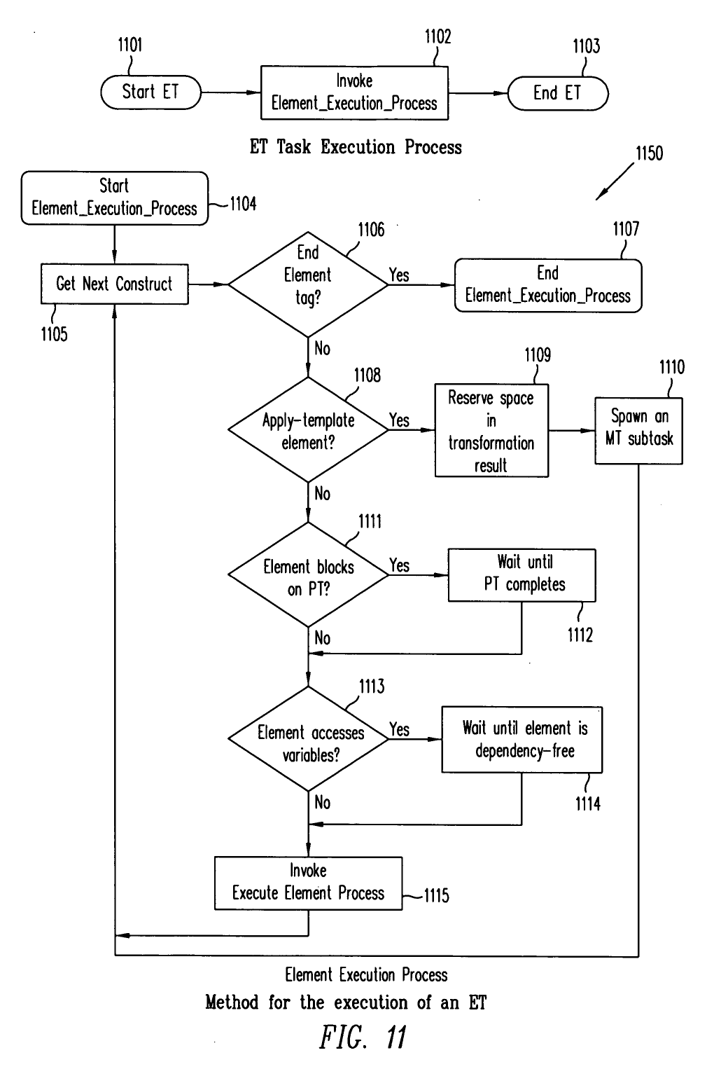

FIG. 9 illustrates a process for executing an MT subtask, according to one embodiment of the present invention. As shown in FIG. 9, at step 902, the process of FIG. 9 begins to evaluate the node set XPath expression associated with the MT subtask. At step 903, for each node contained in the generated node set, a matching template is selected for the node, space is reserved for the transformation result, and an ET subtask associated with the node is spawned. At step 904, if the evaluation partially completes (i.e., the MT subtask expects further nodes to be added into the node set by a corresponding PT subtask which has not completed, see the discussion below in conjunction with FIG. 10), the MT subtask is added to a blocked list of the PT subtask that blocks it (step 905). Control is then yielded to the scheduler. When the blocking PT wakes up the MT subtask after one or more new nodes are added to the node set, evaluation continues at step 906. At step 906, space is reserved in transformation result and an ET subtask is spawned for each newly added node. The evaluation continues until all nodes generated in the node set are evaluated.

FIG. 10 illustrates a process for executing a PT subtask, according to one embodiment of the present invention. As shown in FIG. 10, a PT subtask is initiated at step 1001. At step 2002, if the next construct is a “START_ELEMENT” tag, indicating a new child element is encountered, the PT subtask spawns a child PT subtask (step 1003) for this child element. Control is then yielded at step 1005 to allow execution of the child PT subtask. When the child PT completes, the PT subtask puts itself back into the XSLT subtask list (step 1004), and yields control to the scheduler (step 1005). When the scheduler returns control back to the PT subtask, the PT subtask checks if the next construct is “START_ELEMENT” (step 1002) or “END_ELEMENT” tag (step 1006). If the next construct is not a “START_ELEMENT” tag or an “END_ELEMENT” tag, parsing is not complete, and further parsing is carried out at step 1007. However, at step 1006, if the next construct is an “END_ELEMENT” tag, the current PT subtask is completed. The parent PT subtask is then placed back on the XML subtask list, and control is yielded back to the parent PT subtask (step 1008). The current PT subtask thus terminates (step 1009).

FIG. 11 illustrates a process for executing an ET subtask, according to one embodiment of the present invention. As shown in FIG. 11, the ET subtask initializes at step 1101. At 1102, an element execution process (flow chart 1150) is invoked. In flow chart 1150, which initializes at step 1104, the next construct in an associated template is obtained (step 1105). If that next construct is an “END_ELEMENT” tag, evaluation is complete, and the process of flow chart 1150 completes (step 1107). Thereafter, at step 1103, the ET subtask completes. Control is then returned to the scheduler.

At step 1106, if the next construct is not an “END_ELEMENT” tag, the ET subtask examines if the next construct is an “Apply-template” element (step 1108). If the next construct is an “Apply-template” element, space is reserved in transformation result (step 1109), and an MT subtask is then spawned for the element (step 1110). If the current ET subtask is blocked on a PT task (i.e., the next construct depends on results of an executing PT subtask that has not completed), the ET subtask is placed in a blocked list of the PT subtask (step 1111). If the ET subtask requires accesses to variables, the variables are checked to determine if their values are free of unresolved dependency (e.g., if any variable is waiting to receive a value from an evaluation which is not yet complete). The ET subtask blocks until the element is dependency-free (step 1112). When element evaluation is ready (step 1115), the element is evaluated (step 1115). After the evaluation of the element, the ET subtask returns to step 1105 to get the next construct.

In the embodiments described above, by way of example, the multiprocessing system is assumed to have identical processors (i.e., run at the same speed, consume the same power, and have the same local cache configuration), which share the same memory architecture. A global control function is typically assigned to one of the processors, to coordinate scheduling all functional components, including the special purpose hardware evaluation (“XPathMat”) components for evaluating XPath expressions. The static inputs considered by the scheduling algorithm for each XPathMat component are the same for each processor. However, the dynamic inputs to each processor may differ depending on the capability of the architecture and system software.

Alternatively, the processors may include both general-purpose, programmable processor and dedicated coprocessors or hardware blocks, which are designed specifically for the execution of certain XPathMat subtasks, or provide an architectural design that aligns closely with the processing requirements of XPathMat subtasks.

In one embodiment, a single instance of a scheduler, assigned to execute on one of the general-purpose processors, is responsible for the scheduling of all subtasks to be run on the available processors.

As a third alternative, when a document tree for the source document already exists, parsing is not required. Thus, in that embodiment, the XSL transformation directly acquires the document tree, and does not invoke the root element parsing method of FIG. 1.

In one embodiment, each ET or MT subtask is associated with a data dependency flag (DDF). The rules for setting and clearing of this flag are: (a) a subtask not created by another subtask is created with a cleared DDF flag; (b) when a subtask with a cleared DDF flag creates subtasks, it raises its own DDF flag and clears the DDF flag of its first child subtask, but raises the DDF flag for other children subtasks; (c) when a subtask with a raised DDF flag creates subtasks, the DDF flags for all its children subtasks are raised; and (d) when a subtask with a cleared DDF flag completes, the subtask sends a “CLEAR” signal to sibling subtasks, if any, and absent any sibling subtask, to its parent task. The transformation process completes when the subtask does not have a parent task. When a subtask receives a CLEAR signal, the CLEAR signal is forwarded to its first child subtask that has not yet completed.

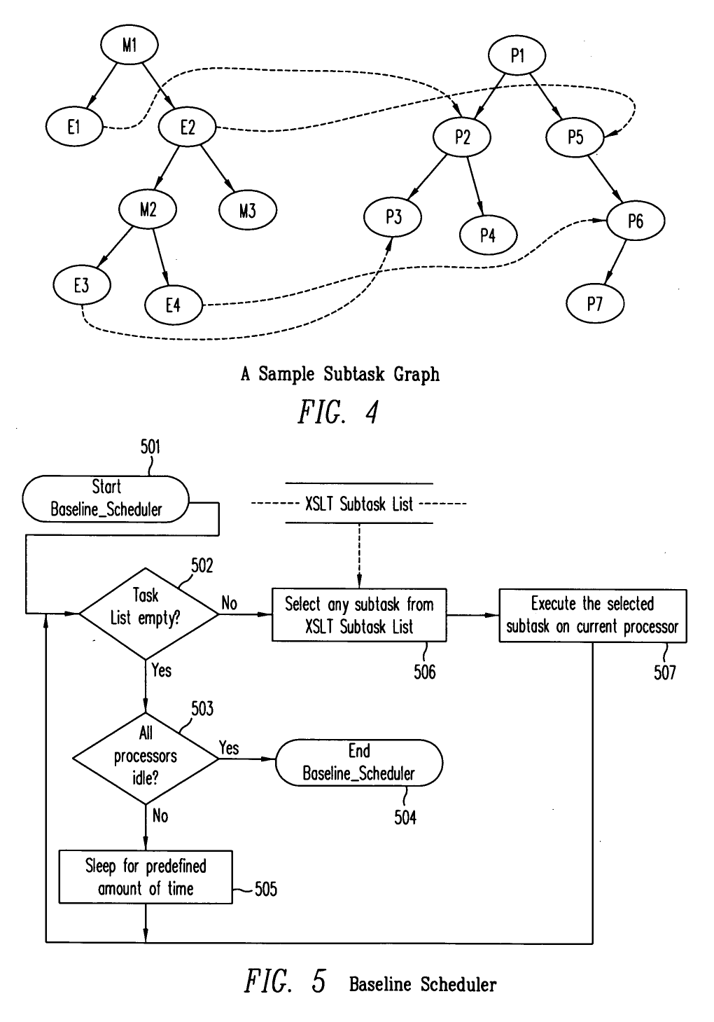

FIG. 4 shows a task graph illustrating an XSLT process on root node parsed in PT subtask P1. As shown in FIG. 4, ET subtasks E1, E2, E3, and E4 are created from PT subtasks P2, P5, P3, and P6, respectively. These dependencies are determined from the structure of the source documents and the associated style sheet or style sheets. For example, ET task E1 depends on PT task P2 because, during the execution of ET task E1, E1 may require information provided from PT task P2 (e.g., E1 may determine if a node named “ABC” is a child node of the source document handled by P2).

The above detailed description is provided to illustrate the specific embodiments of the present invention and is not intended to be limiting. Numerous modifications and variations within the scope of the present invention are possible. The present invention is set forth in the following claims.

We claim:

1. A method for parallel processing of a structured document transformation in a computer system having multiple processors, comprising:
receiving a structured source document and a style sheet;
Spawning a parsing task for a root node of the source document structure, and putting the parsing task onto a task list;
Spawning a evaluation task for the root node, and putting the evaluation task onto the task list;
providing a scheduler running on each of the processors, each scheduler selecting a task at a time from the task list to be executed by the processor on which the scheduler is running.

2. A method as in claim 1, wherein the execution of a parsing task recursively generates a parsing task for each child node and puts the newly created parsing task onto task list.

3. A method as in claim 1, wherein the execution of an evaluation task spawns a matching task for each template matching statement and puts the newly created matching task onto task list.

4. A method as in claim 3, wherein the execution of a matching task matches zero or more nodes parsed by parsing tasks to zero or more templates in the style sheet.

5. A method as in claim 4, further comprising, upon matching a node parse by a parsing task to a template in the style sheet,, creating an evaluation task to evaluate the template with the corresponding node and placing the evaluation tasks to the task list.

6. A method as in claim 1, wherein the scheduler selects the task from the task list according to profile data relating to execution time.

7. A method as in claim 1, wherein the scheduler selects the task from the task list according to profile data relating to energy consumption.

8. A method as in claim 7, wherein the scheduler selects the task from the task list also according to profile data relating to execution time.

9. A method as in claim 8, wherein the task is selected based on a weighted combination of execution time and energy consumption factors in accordance with on power availability.

10. A method as in claim 1, wherein the scheduler selects the task from the task list according to both static profile data and dynamic profile data.

11. A method as in claim 10, wherein dynamic profile data comprises one or more of processor load, bus bandwidth, battery level and data dependency factors.

12. A method as in claim 10, wherein the static profile data are provided in a profile data table, and wherein the dynamic profile data is used to adjust the static profile data in the profile data table from time to time.

13. A method as in claim 1, wherein the task list is accessed via a mutual exclusion mechanism.

14. A method as in claim 1, wherein the processors have identical capabilities.

15. A method as in claim 1, wherein some of the processors comprise a processor customized for XML document processing.
